(19) United States
(12) Patent Application Publication
(10) Pub. No.: US 2004/0100081 A1
(43) Pub. Date: May 27, 2004

(54) Passive protection device and vehicle equipped therewith

(76) Inventors: Jean-Michel Laborie, Meru Cedex (FR); Sonia De Weduwe, Meru Cedex (FR); Stephane Gobier, Paris (FR)

Correspondence Address: YOUNG & THOMPSON, 745 SOUTH 23RD STREET 2ND FLOOR, ARLINGTON, VA, 22202

(21) Appl. No.: 10/430,191

(22) Filed: May 7, 2003

(30) Foreign Application Priority Data
May 7, 2002 (FR) 02 05700

(51) Int. Cl. B60R 21/045

(52) U.S. Cl. 280/752

(57) ABSTRACT

Device for protecting the lower limbs of an occupant of a motor vehicle, the device comprising an energy absorbing structure having two energy absorbing elements which elements become deformed substantially according to the principal direction of application of the force and cooperating with one front support element which extends transversely to the principal direction of application of the force, the front support element having, or cooperating with, a bulge which is convex towards the occupant, at least in the absence of exerted force, the bulge being located between the two energy absorbing elements, in order to cause the occupant's lower limbs to have a minimum distance between them when the energy absorbing structure becomes deformed.

The invention relates to a device for protecting the lower limbs of an occupant of a motor vehicle.

The invention relates also to a vehicle equipped with such a device.

In order to protect the lower limbs of an occupant of a motor vehicle, it has already been proposed to use a system having an inflatable cushion (typically called an air bag).

The invention does not provide the use of an inflatable cushion for protecting the lower limbs but, on the contrary, provides a passive protection system equipped with at least one energy absorbing structure which works “by displacement”, by deformation.

In this context, the problem which arises relates to the position which the occupant's lower limbs must assume in order to be positioned correctly with respect to the energy absorbing structure and to be directed so that the risk of breaking of the limb or other serious damage is limited.

That is true especially in the case of the driver of the vehicle, since the steering column is located substantially between his legs.

It is therefore a question of promoting correct positioning of the occupant's lower limbs when there is a risk that an element or component of the vehicle located opposite the occupant will cause the limbs to be positioned inappropriately, in the central part.

According to a proposed solution, the passive protecting device comprises two energy absorbing elements which become deformed substantially according to the principal direction of application of the force (at the time of the impact) in order to absorb (at least some of) its energy, the two energy absorbing elements being at a distance from one another, perpendicularly to the principal direction of application of the force, and each having at the front a first end close to the occupant, opposite which there is arranged part of at least one front support element which extends transversely to the principal direction of application of the force, the front support element having, or cooperating with, a bulge which is convex towards the occupant, at least in the absence of exerted force, the bulge being situated between the two energy absorbing elements, in order to cause the occupant's lower limbs to have a minimum distance between them when the energy absorbing structure becomes deformed.

A compact and light-weight construction is thus possible.

In order to control the effective movement of the occupant's lower limbs at the time of the impact (which impact is here assumed to be applied substantially according to the axis of forward movement of the vehicle, at the front or rear thereof), it has been found that too great a distance between the occupant's legs may result in incorrect positioning thereof, with respect to the energy absorbing structure, at the time of the impact.

According to a feature of the invention, it is therefore advantageous for the two energy absorbing elements each to have a principal axis of thrust which is directed substantially parallel to the principal direction of application of the force, the distance separating those two axes being greater than about 240 mm, to within about 10%.

In particular when the passive safety device is applied to the driver of the vehicle and is therefore located in the vicinity of the steering column, the latter may constitute a “point of resistance” which is too great under extreme conditions.

Accordingly, it is advantageous for the front support element to connect together the two energy absorbing elements and to be mechanically weakened between the two absorbing elements, in order to bend at that point when the force is applied thereto.

The front support element will thus be able to “wrap itself” around the steering column, especially at the location of the above-mentioned bulge if the weakening is provided at that point, even though it is advantageous to avoid as far as possible contact between the front support element and the steering column at the time of an impact.

It will additionally be noted that the fact of connecting together the two “lateral” energy absorbing elements increases the overall cohesion of the device and allows a considerable degree of effectiveness to be maintained in terms of energy absorption, even if the force (or the direction according to which the occupant's lower limbs come into contact with the device) comes at an angle relative to the longitudinal axis of forward movement of the vehicle (the angular difference may reach 30°).

In particular where the two lateral energy absorbing elements are connected together in that manner, and all the more so if the support element is mechanically weakened between them, it is advantageous according to another feature of the invention that the front support element becomes deformed and/or is articulated, while the energy absorbing elements themselves become deformed, in order to create, between the energy absorbing elements and on either side of the bulge, two cradles for receiving part of the occupant's lower limbs.

It will also be noted that such a feature of deformation and/or articulation of the front support element is of value, when the above-mentioned distance of about 240 mm between the principal axes of thrust is respected, because it is then ensured that the distance between the lower limbs is, a priori, neither too great nor too small and that, consequently, they can be directed precisely away from hard, mechanically resistant areas (especially the steering column, fuse box, central control panel of the dashboard, etc.).

In another possible configuration, the front support element, which is again provided for connecting together the two energy absorbing elements, is made of metal, is deformable and is deformed during the force, so that it is flatter after the force than before the force.

In that case, it is advantageous for the above-mentioned convex bulge to be mechanically weakened locally (in order to be flattened at the time of the impact, following the force exerted by the occupant's lower limbs) and/or for it to be possible for the front support element to be displaced (to slide) or even to be articulated (to bend) at the location of the two lateral energy absorbing elements.

Optionally in relation to the above, and more generally to promote better directional control of the occupant's lower limbs during the period of application of the force following the impact, it is advantageous that, transversely to the principal direction of application of the force, the front support element extends beyond the energy absorbing elements. The occupant's lower limbs will accordingly continue to encounter a zone of the passive protecting device, on either side of the energy absorbing elements, which can occur especially if the occupant's legs are markedly further apart than the normal position in which they should be located.

Another problem taken into consideration by the invention relates to the possibility of providing a relatively great displacement distance of at least one part of the energy absorbing structure, under a constant load, with optimum conditions of reliability, effectiveness and cost, while ensuring that the front support element is stable at the time of that displacement following the impact, without necessarily having to use an articulated lateral guide means, for example in the form of movable beams or bars.

In order to achieve that object, the energy absorbing structure, according to a feature of the invention, may comprise at least one honeycombed structure defining elongate cells which extend parallel to one another, in a direction transverse to the principal direction of application of the force.

Accordingly, it is possible to obtain considerable displacement with a constant force.

In relation to the above, and even if such a honeycombed structure is not used, it is advantageous according to another feature of the invention that at least one of the energy absorbing elements may have a first front base having a smaller cross-section than a second rear base, the first front base facing the limbs of the occupant of the vehicle, the second rear base being located opposite.

In that case, the second rear base stabilises the energy absorbing structure angularly, even when the application of forces is offset relative to the longitudinal axis of forward movement of the vehicle.

In the course of deliberations carried out within the scope of the invention, it has been noted that the effectiveness of the passive protecting device is further reinforced when:

the front support element is located substantially opposite the occupant's knees, and

the device further comprises an additional front support element which extends lower than the first front support element, opposite the occupant's tibias.

The following two features are also advantageous, as alternatives or in combination:

the first front support element is in the form of a tubular (hollow) beam or in the form of a bar, and the additional front support element is in the form of a plate, so that the additional front support element has a support surface for the lower limbs which is larger than that of the first support element,

the first and second front support elements are of such a size that the first front support element, during the application of the force, absorbs from three to eight times the force absorbed by the additional front support element (to within about 10%).

It is thus possible to provide the best possible protection for the limbs, by distributing the force between the knees and the tibias, optionally by “loading” the tibias a little, but without increasing the risk to the occupant (the load is always essentially supported substantially at the level of the knees). The standards of “physical loads” are also respected.

With regard to the production of the additional support element, it will also be noted that, advantageously:

it strengthens the dashboard of the vehicle in question locally and mechanically,

and/or it incorporates deformable walls which are oriented substantially parallel to the principal direction of application of the force, and which, by deforming under the force, absorb at least some of the energy developed thereby.

With regard to the area in which the protecting device of the invention is mounted, it will be noted that the energy absorbing elements associated with the (first) front support element will be located behind the dashboard, relative to the occupant.

With regard to the front support element itself, it is advantageously separate from the layer(s) of the dashboard and therefore also located behind the dashboard.

It will thus be possible to produce that element in the form of a beam or bar.

By contrast, if the additional support element for the tibias is to be used, it will preferably be in the form of a plate located, perpendicularly to the principal direction of application of the force, at the level of the dashboard or behind the dashboard relative to the occupant, and, in terms of height, beneath the first front support element and below the level at which the energy absorbing elements are located.

The plate form allows the additional element to be incorporated into the layers of the dashboard or, on the other hand, to be arranged behind the dashboard, the effect of distribution of the force over the surface of the plate being obtained in both cases equally.

By contrast, it is advantageous in both cases for the additional support element to include deformable walls which are oriented substantially perpendicularly to the principal direction of application of the force and which, by deforming under the force, absorb at least some of the energy developed thereby.

Such an embodiment combines effectiveness and reduced cost.

In the above, reference was made at one point to the use of articulated arms for stabilising the protecting device according to the invention and ensuring favourable absorption of the force.

On that assumption, it is advantageous for the two energy absorbing elements each to comprise a beam which is connected at a first upper end to the front support element and is articulated, at a second lower end, transversely to the direction of application of the force and substantially horizontally, with a fixing flange which is fixed rigidly to a cross-member for mechanically reinforcing the dashboard, to which cross-member the dashboard is fixed and which extends inside the vehicle, substantially parallel to the front support element and between the A pillars of the vehicle.

A more detailed description of the invention will now be provided with reference to the attached drawings, in which:

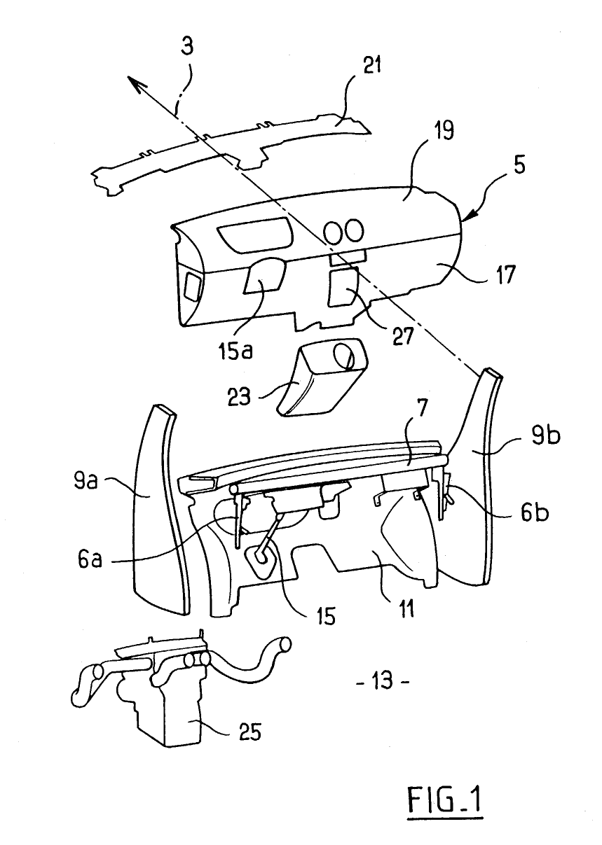

FIG. 1 shows an exploded view of a number of elements of the structure and/or trim of a motor vehicle,

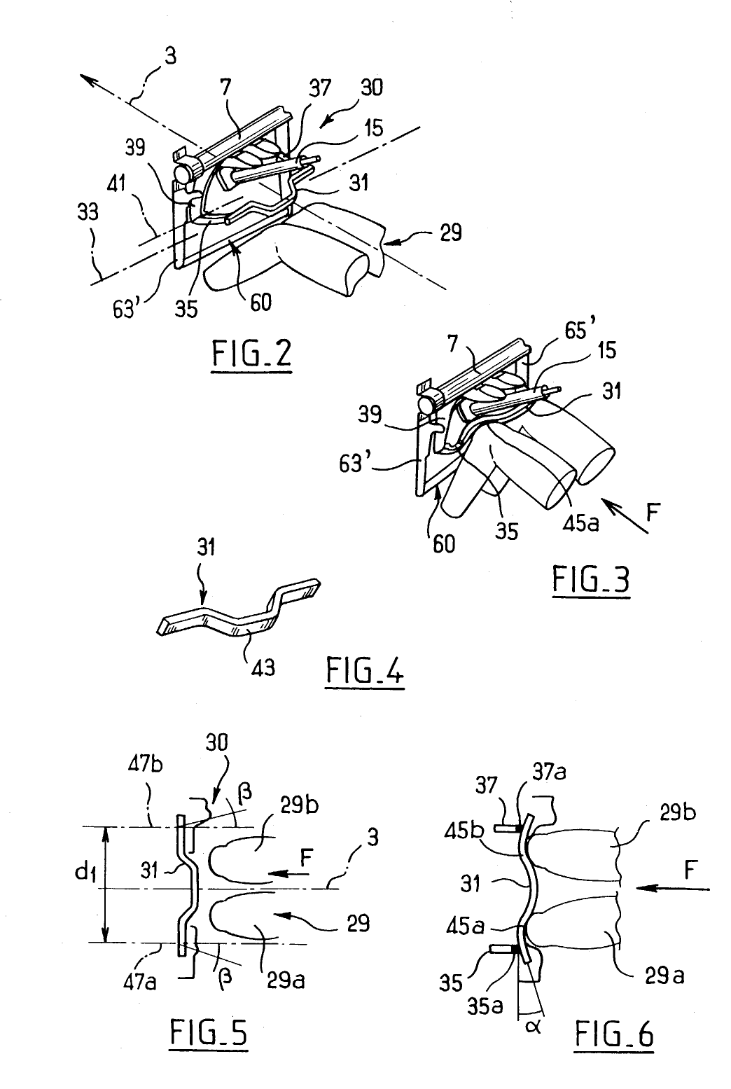

FIGS. 2 and 3 show an operating principle of a passive safety system before impact and after impact, respectively,

FIG. 4 shows an enlarged view of a possible embodiment of the front support element which receives the occupant's knees,

FIGS. 5 and 6 show a diagrammatic plan view of the deformation of the front support element, as already shown in FIGS. 2 and 3,

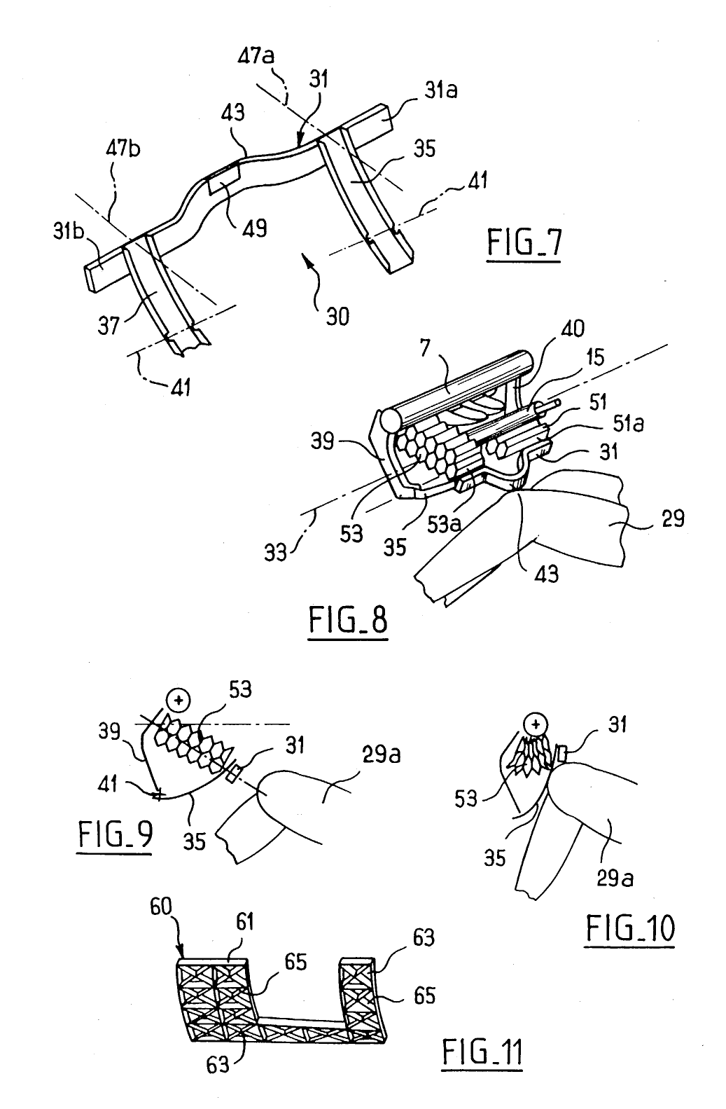

FIG. 7 shows a rear view of the locally weakened front support element with two lateral energy absorbing beams,

FIG. 8 shows a perspective view of a variant of the energy absorbing zone, around the steering column,

FIGS. 9 and 10 show a diagrammatic side view of the operation of the safety system of FIG. 8,

FIG. 11 shows a protecting plate for the tibias,

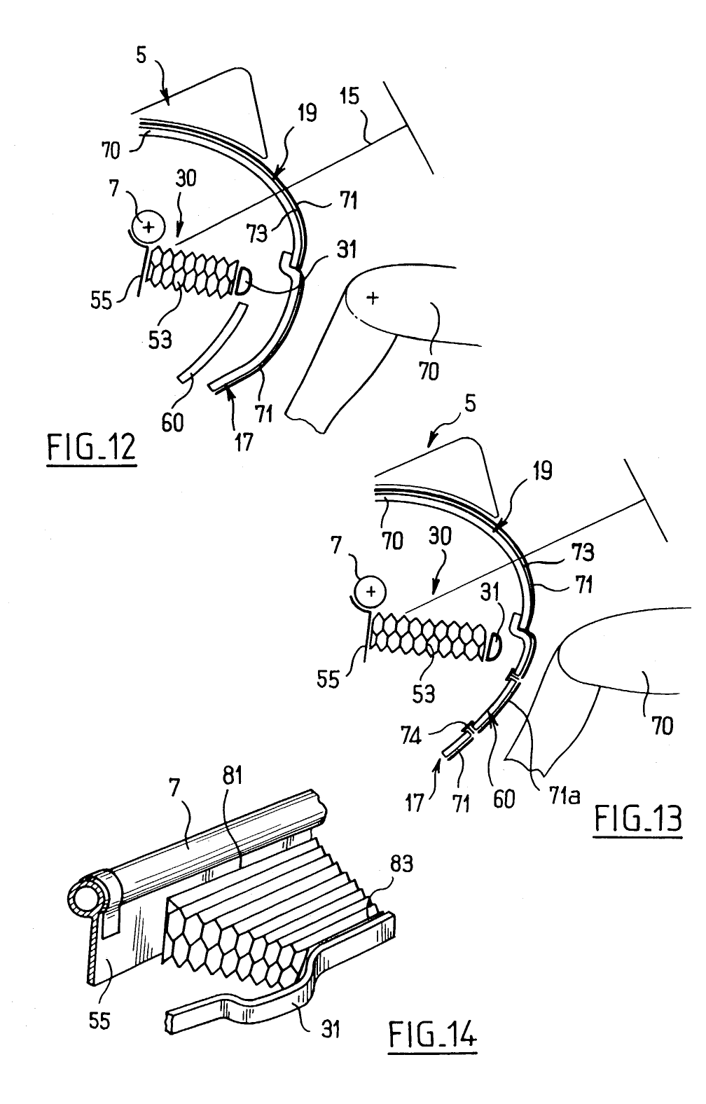

FIGS. 12 and 13 show diagrammatically, in vertical section, a dashboard equipped with protection systems for the knees and tibias, according to an embodiment of the invention,

and FIG. 14 shows a variant in which there is shown an energy absorbing element having a rear support surface which is larger than its front surface.

FIG. 1 therefore shows various essential elements of a dashboard 5, which is fixed rigidly and laterally, by means of lugs 6a, 6b, to a cross-beam 7 which extends perpendicularly to the axis 3 (longitudinal direction of forward movement of the vehicle on which the dashboard is mounted) and whose purpose, as is known per se, is to contribute towards strengthening the vehicle at the location of its dashboard, while providing a solid fixing for the dashboard.

The cross-beam 7 is fixed laterally to the A pillars 9a, 9b of the vehicle and/or to the front apron 11 which conventionally separates the engine compartment (located at the front) from the cabin 13 in which the occupants of the vehicle are located.

15 denotes diagrammatically a portion of the steering column which is fixed to the cross-beam 7.

The dashboard 5 comprises in particular a dashboard body 17 on which there is mounted a cover 19 to which there is connected, at the location of the windscreen (not shown), a fascia panel 21.

The location 15a shows the passage at the point at which the steering column 15 passes through the dashboard body.

23 designates the upper and lower shells which surround the part of the steering column that is visible from the cabin, at the location of the passage 15a.

The air-conditioning unit is designated 25 and is engaged behind the central control panel 27 of the dashboard.

In the following, greater importance has been given to the application of the invention for protecting the driver.

Accordingly, for example in FIGS. 2 and 3, 29 designates the driver's lower limbs, which are arranged opposite the steering column 15.

In this embodiment, the protecting device comprises a front support element 31 elongated according to a direction 33 which is transverse to the longitudinal axis 3 and which is a priori horizontal, and also two articulated beams or bars 35, 37 to which the front support element 31 is fixed towards its lateral ends, the two beams 35, 37 themselves being fixed at a second end to rigid and fixed force recovery arms (or flanges) 39, 40 (see FIG. 8), the two arms themselves being rigidly fixed to the transverse beam 7.

Accordingly, the front support element 31 preferably connects together the lateral beams 35, 37. This promotes the controlled distribution and the compensation of the force at the time of the impact.

Typically, the elements 31, 35, 37 and 39 will be made of metal, and the beams 35, 37 will absorb the energy, in the case of an impact substantially parallel to the axis 3, by articulation at the site of their connection to each arm, such as 39, as will be seen in FIG. 3 (condition of the device following the impact), the axis of articulation between the beams and the arms here being substantially parallel to the direction 33, as is shown by the axis of articulation 41, at the site of connection between the beam 35 and the arm 39.

Rather than a curved shape (with convexity directed towards the occupant), the beams 35, 37, which are advantageously arranged substantially vertically, or at least are advantageously arranged to pivot in substantially vertical planes, may be substantially omega-shaped (Ω).

They may be U-shaped profiles, made of steel.

In FIG. 4 it will be seen that the front support element 31 comprises in its intermediate (central) portion a bulge 43 which is oriented with a convexity directed towards the occupant seated in the cabin.

The element 31 may especially comprise a curved metal tube of rectangular cross-section.

FIGS. 5 and 6 show the front support element 31 before the impact and then after the impact, respectively. In FIG. 5, the front support element 31 has the same shape as in FIG. 4, and the occupant's lower limbs 29 are still located at a distance from that bar.

In FIG. 6, on the other hand, the knees 29a, 29b have moved apart and are located on either side of the bulge 43 (by which they have been guided), and the support element 31 has become deformed, creating two cradles 45a, 45b (see also FIG. 3 for the cradle 45a) between the bulge 43 and the lateral zones 35a, 37a, which provide the rigid connection between the front bar 43 and the energy absorbing beams 35, 37.

In FIG. 6 there will be noted the angle α which arises from the deformation of the front bar 43 and of the connection zones 35a, 37a: the beams 35, 37 have therefore twisted close to their upper ends at the same time as articulating in substantially vertical planes, in their lower portions.

It will also be seen from FIGS. 5 and 6 that, both before and after the impact, the occupant's lower limbs 29, located opposite the protecting device 30, are located between the two axes 47a, 47b which in the present case pass through the fixing zones 35a, 37a and which, more generally, define the principal axis of application of the force, symbolised by F. Those axes, which are of course parallel to the direction of the force F, are parallel to the longitudinal axis 3 of the vehicle, it being stated, however, that it is possible in the invention to achieve an angular offset β in the orientation of the force F, and therefore in the orientation of the axes 47a, 47b, which can reach 30° on either side of the axis 3.

The axes 47a, 47b each represent the axis according to which the resultant of the force F is applied at the location of each of the two energy absorbing elements which are associated with the front support element and which are defined in the present case by the beams 35, 37.

In order to ensure correct positioning of the lower limbs 29 relative to the two axes 47a, 47b, the invention provides a distance d₁ between those axes which is greater than 240 mm, to within about 10%. That is advantageous for controlled displacement of the lower limbs 29 during the impact and for the formation of their receiving cradles 45a, 45b, thus avoiding the tendency of the limbs to move too far apart, with the risk of placing the occupant in a dangerous position.

FIG. 7 shows the two energy absorbing beams 35, 37 and the front support element 31 with its curved central portion 43.

In this case, the curved central portion is weakened on its rear side 49 so that the bulge 43 will bend during the absorption of the force, and especially in the case where bending of the beams 35, 37 would bring about contact between the front support element 31 and the steering column : the mechanical weakening 49 then allows the front support element 31 to “wrap itself” around the steering column without an excessively resistant hard point touching the occupant's legs 29.

FIG. 7 also shows scalloping in the lower portion of the beams 35, 37, allowing the articulation of the beam 35, especially about the axis 41, which is necessary for absorption of the force.

It will also be noted that the front support element 31, which is again in the form of a hollow beam in this case, extends laterally, at 31a, 31b, beyond the two energy absorbing elements 35, 37 and therefore beyond the axes 47a, 47b.

It will be noted that the lateral prolongations 31a, 31b allow the device 30 to retain its effectiveness and to control the displacement of the occupant's legs, even if they tend to move apart laterally, beyond the axes 47a, 47b.

The lateral prolongations are also valuable should the spacing between the two energy absorbing elements such as 35, 37 close up, whether those elements be beams or other elements such as, for example, the honeycombed structure of FIGS. 8 to 10.

It will also be noted that, especially when the front support element 31 is mechanically weakened between the two lateral energy absorbing elements, it may be advantageous to control the deformation of the energy absorbing elements, for example by twisting at the location of the zones 45a, 45b, so that the front support element 31 is flatter after absorbing the force than before the impact. In order to achieve that effect, another solution may consist in providing for possible sliding of the front support element 31 (especially if it is a bar or a beam) according to the general direction 33, it being possible to provide for that purpose flanges (not shown) in the region of the end at which the beams 35, 37 are connected to the element 31. In that manner, the excess central length of that element created by its flattening during the impact would lead to its sliding in said flanges, on the left- and right-hand sides.

FIGS. 8 and 9 show, in succession (more diagrammatically in FIG. 9), another proposed solution of the invention for providing the required passive safety.

In this case, the front support bar 31 is located with its bulge 43 opposite the steering column 15, and the lateral energy absorbing beams (only beam 35 is shown) are connected in an articulated manner to the arms 37, 39 for connection to the transverse beam 7. 29 again designates the lower limbs of the occupant (of the driver in the present case).

A notable feature of this solution is the presence of the alveolar (or honeycombed) structures 51, 53 which are provided on either side of the steering column 15 for absorbing the energy at the time of the impact.

It will be noted in this respect that the alveolar structures 51, 53 may be used on their own, without the bars and beams 35, 37, 39, it being possible for the front support element 31 to be fixed to the wall of the forwardmost cells, as at 51a and 53a in FIG. 8.

As will be seen more clearly in FIG. 8, each alveolar structure 51, 53 is defined by elongate tubular (hollow) cells which extend parallel to one another and in the general direction 33, that is to say perpendicular to the longitudinal axis 3 of forward movement of the vehicle, or in other words, parallel to the principal direction of extension of the front support element 31.

In the illustration of FIG. 8, there are two separate sets of honeycombed energy absorbing structures, each of which rests to the rear on a locking means (such as a rigid, mechanically resistant plate) which is shown diagrammatically at 55 in FIGS. 12 to 14 and is fixed to the cross-beam 7 in order to support the alveolar structures to the rear. However, it is also possible for the two lateral structures 51, 53 to be connected together at the front (not shown) by means of an intermediate portion which is likewise of alveolar structure (prolongation parallel to the direction 33 of the forwardmost cells), so as to obtain an approximately horizontal, substantially U-shaped honeycombed structural assembly.

That front connection, opposite the occupant, of the two lateral energy absorbing elements would be advantageous to stability during deformation and would ensure additional retention at the time of the impact in the central zone, opposite the steering column.

FIGS. 9 and 10 show diagrammatically the deformation especially of the alveolar structures at the time of an impact according to the axis 3.

It will be seen in FIG. 10 that the front support element 31 is raised, during the impact, above the level of the knee 29a of the occupant that is shown, while the cells of the structure 53 shown have been flattened and are now oriented almost horizontally, whereas they were inclined by about 30° in FIG. 9, before the impact.

The articulation at 41 of the energy absorbing beam 45 will also have been noted.

In view of FIGS. 2, 3, 8, 9 and 10 in particular, it will be seen that the energy absorbing system which has just been described is intended especially to be arranged opposite the knees of the occupant of the vehicle, especially if the occupant is the driver.

However, returning to FIGS. 2 and 3, it will be noted that, in addition to protecting the knees, the device of the invention may comprise an additional system, designated 60 as a whole, which is intended to protect the tibias. It is, of course, arranged below the front support element 31.

In FIGS. 2 and 3, that system is illustrated by a transverse beam which can be deformed under the force F to absorb some of the energy of the impact and which is able to strengthen the dashboard locally and mechanically.

Given the stresses to be withstood by the tibias at the time of an impact, it is advantageous for the protection system 60 to comprise an additional support element in the form of a plate which provides a larger support surface for the lower limbs than does the first front support element 31, as is shown in FIG. 11, in which the element protecting the tibias comprises a plate 61.

The plate, which extends globally according to a plane perpendicular to the axis 3, may be curved with a slight convexity directed towards the occupant. It is advantageously U-shaped in order to be associated with the dashboard.

Opposite the occupant, it additionally advantageously has a succession of chambers 63 and/or a series of ribs 65 arranged perpendicularly to the general plane in which it extends.

The ribs 65 constitute integrated, deformable walls which are directed substantially parallel to the direction of application of the force F and which, by deforming under that force, will absorb at least some of the energy developed thereby at the time of the impact.

The plate 61 will preferably be made of plastics material having rigidity suitable for subjecting the tibias to a lesser load than that exerted by a bar.

It will be noted that, by combining the two front support elements 31 and 60, especially when the first front support element 31 is a bar (more particularly a tubular beam) and the second front support element 60 is a plate incorporating the energy absorbing elements 63, 65, it will be possible to optimise the manner in which the passive safety of the lower limbs of the occupant is ensured. In this respect, it is highly advantageous for the size of the first and second front support elements 31, 60 to be such that the additional support element 60 for the tibias absorbs between about 1/8and 1/3of the force absorbed by the first support element 31 for the knees (and its associated energy absorbing structure). In that respect, with about 700 Joules to be absorbed at the time of an impact, the distribution will preferably be as follows: from about 5.5 to 6 kN for the knees (front support element 31 with its lateral energy absorbing elements) and from about 1 to 1.5 kN for the tibias (support plate 60 with its integrated energy absorbing structure 63, 65).

FIGS. 12 and 13 show two preferred possible methods of mounting the protecting device 10.

In the case of FIG. 12, the additional energy absorbing element 60 arranged opposite the tibias of the occupant 70 is located behind the structure of the dashboard 5, while in the case of FIG. 13, the additional element 60 is located at the level of the structure of the dashboard with which it is structurally integrated.

Each figure shows the lower body of the dashboard 17, the cover 19, the strengthening cross-beam 7, the steering column 15 and the energy absorbing device 30 located opposite the knees of the occupant 70, with its front support element 31 behind which there extends the energy absorbing structure, which is here constituted by the transverse tubular cells already described in detail with reference to FIGS. 8 to 10, of which one set 53 has been shown here, before the impact has occurred.

The shock-absorbing assembly 30 for the knees is arranged behind the structure of the dashboard with, beneath the front support element 31, the force absorbing plate for the tibias 60, which is therefore arranged substantially vertically, the two elements 31, 60 being located substantially following on from one another.

The additional energy absorbing element 60 can be fixed as shown in FIGS. 2 and 3, that is to say by means of lateral flanges 63′, 65′ which are fixed in their upper portion to the cross-beam 7.

In each of FIGS. 12 and 13, it will also be noted that the dashboard 5 comprises structurally, for its constitution, at least one layer 70 of rigid structuring plastics material, which may be covered with a covering layer 71 on its outer face directed towards the cockpit 13, optionally with the interposition of an intermediate layer of expansible plastics foam 73.

Accordingly, in FIG. 13, it will be noted that the back layer of rigid plastics 70 has locally, beneath the steering column 15, a large opening at the location in which the energy absorbing plate 60 has been positioned, which plate is therefore integrated into the dashboard in this case and strengthens it mechanically. Fixing thereof to the rigid plastics layer 70 may be carried out by means of fixing lugs 74 or any other suitable fixing means allowing the plate 60 to be held in position. Optionally, the cells produced by the front grid of the plate may be filled with foam, the whole being covered by the covering layer 71a, which may comprise a very fine layer of plastics material, preferably separate from the layer 71 which also covers the dashboard.

In a figure not shown, it would also be conceivable for the first front support element 31 to be arranged through the opening 15a in the dashboard (see FIG. 1) and therefore not arranged behind the dashboard, although structurally separate therefrom. Optionally, the element 31 may be visible to the occupant through an opening such as the opening 15a in the dashboard.

In FIG. 14, the lateral energy absorbing elements associated with the element 31 (only one has been shown) each comprise an alveolar structure 80 having a rear base 81 close to the cross-beam 7 (support plate 55) having a larger cross-section than the front base 83 on which the element 31 rests, in order to promote stability and the control of the movements at the time the impact.

Optionally, the front support element may be without a “central” bulge, the latter then being provided, if necessary, on an associated element, such as, for example, the steering column, which may then have a knee-guiding cone located opposite an opening which may have the front support element (preferably in the form of a plate) and in which the cone would engage at the time of the impact.

It is also conceivable to produce the front support element in at least two separate pieces, even though the connection it provides at the front between the lateral energy absorbing elements is advantageous.

1. Device for protecting the lower limbs of an occupant of a motor vehicle, in the case of force exerted on the limbs according to a principal direction (3) of application of the force, the device comprising an energy absorbing structure having two elements (35, 37; 51, 53) which absorb energy by displacement, which elements become deformed substantially according to the principal direction of application of the force in order to absorb the energy thereof, the two energy absorbing elements being at a distance from one another perpendicularly to the principal direction of application of the force and each having at the front a first end close to the occupant, opposite which there extends part of at least one front support element (31) which extends transversely to the principal direction of application of the force, the front support element having, or cooperating with, a bulge (43) which is convex towards the occupant, at least in the absence of exerted force, the bulge being located between the two energy absorbing elements, in order to cause the occupant's lower limbs to have a minimum distance between them when the energy absorbing structure becomes deformed.

2. Device according to claim 1, characterised in that the two energy absorbing elements (35, 37; 51, 53; 80) each have a principal axis of thrust (47a, 47b) which is directed substantially parallel to the principal direction of application of the force, the distance separating those two axes being greater than about 240 mm.

3. Device according to claim 1 or claim 2, characterised in that the front support element (31) connects together the two energy absorbing elements and is mechanically weakened (49) between the two absorbing elements, in order to bend at that point when the force is applied thereto.

4. Device according to claim 1 or claims 1 and 3, characterised in that the front support element (31) connects together the two energy absorbing elements (35, 37; 51, 53) and, under the force, the front support element becomes deformed and/or is articulated at the location of the energy absorbing elements, while the latter themselves become deformed, in order to create, between the two energy absorbing elements and on either side of the bulge, two cradles (45a, 45b) for receiving part of the occupant's lower limbs (29).

5. Device according to claim 2 or claims 2 and 3, characterised in that the front support element (31) connects together the two energy absorbing elements (35, 37; 51, 53; 80) and the mechanical resistance to deformation of the energy absorbing structure is less in two zones located on either side of the bulge and between the two energy absorbing elements so that, under the force, the front support element becomes deformed and/or is articulated substantially at the location of the principal axes of thrust, while the energy absorbing elements themselves become deformed, in order to create, between the two principal axes of thrust, two cradles (45a, 45b) for receiving part of the occupant's lower limbs.

6. Device according to claim 1 or claims 1 and 2, characterised in that the front support element connects together the two energy absorbing elements (35, 37; 51, 53; 80), is made of metal, is deformable and is deformed during the force, so that it is flatter after the force than before the force.

7. Device according to any one of the preceding claims, characterised in that, transversely, the front support element (31) extends beyond the energy absorbing elements.

8. Device according to any one of the preceding claims, characterised in that the energy absorbing structure comprises at least one honeycombed structure (51, 53) defining elongate cells which extend parallel to one another and in a direction (33) transverse to the principal direction of application of the force.

9. Device according to any one of the preceding claims, characterised in that at least one of the energy absorbing elements (80) has a first front base having a smaller cross-section than a second rear base, the first front base facing the limbs of the occupant of the vehicle, the second rear base being located opposite.

10. Device according to any one of the preceding claims, characterised in that:
the front support element is located substantially opposite the occupant's knees, and
the device further comprises an additional front support element which extends lower than the first front support element, opposite the occupant's tibias.

11. Device according to claim 10, characterised in that the first front support element is in the form of a hollow beam or a bar and the additional front support element is in the form of a plate, so that the additional front support element has a support surface for the lower limbs which is larger than that of the first support element.

12. Device according to claim 10 or claim 11, characterised in that the first and second front support elements and the energy absorbing elements (35, 37; 51, 53) are of such a size that the first front support element and the energy absorbing elements absorb, at the time of application of the force, from about three to eight times the force absorbed by the additional front support element.

13. Motor vehicle comprising:
a dashboard (5) comprising at least one layer (70) of plastics material,
a steering column (15),
a device according to any one of claims 1 to 12, characterised in that the front support element (31), which incorporates the bulge (43), is located substantially opposite the occupant's knees, with the bulge located opposite the steering column.

14. Vehicle according to claim 13, characterised in that the front support element (31) is separate from the layer(s) of the dashboard and is located behind it/them, relative to the occupant, in the vicinity of the steering column.

15. Vehicle according to claim 13, characterised in that, at the rear, at a second end further remote from the occupant than the first end, at least before the force has been exerted, the two energy absorbing elements (35, 37; 51, 53) are connected to a transverse bar (7) forming part of the structure of the vehicle, which bar extends transversely to the principal direction (3) of application of the force and is mechanically more resistant to bending than the front support element (31).

16. Vehicle according to claim 13, characterised in that the device for protecting the lower limbs comprises an additional front support element (60) which extends lower than the first front support element (31), opposite the occupant's tibias, the additional front support element mechanically strengthening the dashboard (5) locally.

17. Vehicle according to claim 16, characterised in that the additional front support element (60) incorporates deformable walls (65) which are oriented substantially parallel to the principal direction (3) of application of the force and which, by becoming deformed under the force, absorb at least some of the energy developed thereby.

18. Vehicle according to claim 16 or claim 17, characterised in that the additional front support element (60) is in the form of a plate which is located, perpendicularly to the principal direction of application of the force, at the level of the dashboard or behind the dashboard, relative to the occupant, and, in terms of height, beneath the first front support element (31) and below the level at which the energy absorbing elements (35, 37; 51, 53) are located.

19. Vehicle according to claim 13, characterised in that the two energy absorbing elements each comprise a beam (35, 37) which is connected at a first upper end to the front support element (31) and is articulated, at a second lower end, transversely to the direction of application of the force and substantially horizontally, with a fixing flange (39, 40) which is rigidly fixed to a cross-beam (7) for mechanically strengthening the dashboard, to which the dashboard is fixed, and which extends inside the vehicle, substantially parallel to the front support element and between the A pillars (9a, 9b) of the vehicle.
